(19) United States
(12) Patent Application Publication
(10) Pub. No.: US 2022/0207482 A1
(43) Pub. Date: Jun. 30, 2022

(54) Method of accepting, acquiring, judging, developing, and promoting Screenplays for Digital Media & Film Production

(71) Applicant: Mikhael Bassilli, Granada Hills, CA (US)

(72) Inventor: Mikhael Bassilli, Granada Hills, CA (US)

(21) Appl. No.: 17/139,761

(22) Filed: Dec. 31, 2020

(51) Int. Cl. G06Q 10/10; G06Q 20/08; G06Q 30/02

(52) U.S. Cl. CPC G06Q 10/101; G06F 3/0482; G06Q 30/0212; G06Q 20/085

(57) ABSTRACT

A method of accepting, acquiring, judging, developing, and promoting screenplays is disclosed. Authors from around the world submit screenplays through a web-based, portal competition. The process consists of three competitions: a Logline and Outline contest; a First Draft contest; and a Rewrite Contest. Contestants receive compensation and screen credits in exchange for ownership rights. The finalized screenplay is then promoted among producers and investors for potential media and film productions.

### FIELD OF THE INVENTION

The present invention generally relates to screenplays. More specifically, it relates to a method of submitting, acquiring, developing, judging, and promoting screenplays using an online web portal.

### BACKGROUND

The first films in the early 1800s began as a novelty and were considered a parlor trick using photographic techniques and the newly-invented light bulb to project what looks like moving images on a screen. One of the earliest and most famous demonstrations of film was the Lumiere Brothers' screenings which opened in Paris France on Dec. 28, 1895. It was a collection of 10 short films which had titles such as ‘Workers leaving the Lumiere Factory,’ ‘Bathing in the Sea’ and ‘Baby's Breakfast’-these ‘Scenarios’ films were all approximately 40 seconds long and the opening descriptions were used for both as a description of the film and in marketing. Early filmmakers discovered they could start splicing different pieces of film together to tell a story. George Melies famous ‘A trip to the Moon’ was sketched out as a series of scenarios. These first screenplays written were simply a technical aid for the directors to notate what was to be shot and in what order. By the early 1900s the scenario for Edwin S. Porter's The Great Train Robbery was evidence of what was later to be called the ‘Master Scene Format’ screenplay. In 1911, a small time filmmaker named Thomas Ince revolutionized the filmmaking process by applying scientific principles in the way that Henry Ford revolutionized the automobile industry. Using careful planning for the films, he pioneered the use of the ‘Continuity Script’ which contained information on who was in the scene, the action in the scene, notation for interiors and exteriors, camera requirements and cost control. By breaking down the scenes he could create shooting schedules where he could assign different camera units to produce screenplays and scripts simultaneously. The process of writing and selecting screen plays in the 20^{th} century has generally been considered a privileged industry with large film companies keeping closely-guarded ties with creative professionals. However, with the onset of the internet this process has become more decentralized. United States Patent No. US20140365860A1 granted to Spielberg and Gustman teaches of a system that leverages internet communication for screenplay annotation development. United States Patent No. US U.S. Pat. No. 8,131,132B2 granted to Klappert disclosed an online collaborative system for interactive content contributions. United States Patent No. U.S. Pat. No. 8,341,525B1 granted to Achour, Achour and Anarino disclosed an online collaborative process for script writers that is based on timeline mapping. While these internet-based tools present reliable solutions for script and screenplay generation, what is needed is a process that extends online collaboration through the concept creation and story editing stages as well as through the promotional process made available to the public.

### SUMMARY OF THE INVENTION

The device herein disclosed and described provides a solution to the shortcomings in the prior art through the disclosure of a method of accepting, acquiring, developing, judging, and promoting screenplays. An object of this inventive method is to enhance the creative process of screenplay generation for the general public. Screenwriters from around the world are afforded an opportunity to contribute writings to a single screenplay project thereby enhancing the level of creative inputs and opportunities.

Another object of this inventive method is to leverage global information technologies to provide opportunities to creative writers who may not be privileged to have connections to the screenplay and movie industries. The website will allow anyone with an internet connection to make submissions—even those writers without conventional academic or professional backgrounds, are given an opportunity to submit their work.

Another object of the invention is to allow global input into the various stages of screenplay development. The web-based portal accepts writers who compete to work on loglines, outlines, various screenplay development stages, performing edits on a winning first draft stage, and during a rewrite stage.

Another object of the invention is to allow participating screenplay writers and editors to receive both monetary compensation and recognition through profit sharing and screen credits respectively when a work is eventually sold.

Another object of the invention is to allow individuals who may or may not be connected to the film and entertainment industry to manage and develop a screenplay production and benefit. The web-based portal system itself is made available to the public and anyone can assume control over managing the process of gathering, refining and promoting original screenplays. In addition, the web-based portal hosts receive monetary benefits from the screenwriters who participate—as well as from the sale of any screenplays themselves.

It is briefly noted that upon a reading of this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising” Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 showing a schematic diagram of a portion of the sequence of events undertaken by web-based portal hosts in practicing the inventive method.

FIG. 2 showing a detailed flowchart of the manner of practice of the inventive method for screenwriters.

FIG. 3 showing a screen shot of a page of the website portal contests as part of the inventive method.

FIG. 4 showing a screen shot of a page of the website portal screen generator as part of the inventive method.

Other aspects of the present invention shall be more readily understood when considered in conjunction with the accompanying drawings, and the following detailed description, neither of which should be considered limiting.

### DETAILED DESCRIPTION OF FIGURES

As explained above, the present invention is a software and/or web-based portal method of accepting, acquiring, developing, judging, and promoting screenplays. Writers from around the world enter competitive contests using the web-based portal operated and managed by hosts. The hosts judge uploaded work, select winners, develop the material through subsequent contests as needed, determine reimbursements, and promote screenplays to movie and entertainment industries for a profit. The present invention is practiced using a computer on which software is uploaded, the computer having input means such as a keyboard, and a display, and the computer being connected via a server to the global computer network known as the Internet so that screenwriters can communicate with the server via the Internet in practicing the inventive method. The display can display the website used in practicing the invention. Authorized hosts can gain access to the website including via the Internet.

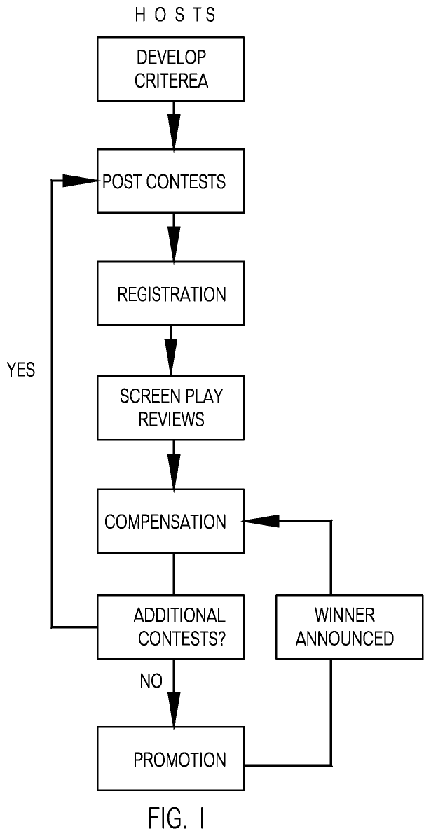

With reference to FIG. 1, the hosts developing questions for script generators and posting on the website portal and saved to computer memory via said server. The hosts posts contest listings on a website portal page comprised of but not limited to: a logline & outline contest; a first draft contest; and a rewrite contest and the like along with rules, guidelines, instructions, and timelines. The host accepts registrations from screenwriters on another website portal page that includes information provided by screenwriters such as but not limited to screen writer's name, address, telephone, email address, professional background etc. as well as collecting payment for participation in a contest (through online payment methods that include but are not limited to paypal, stripe, venmo, direct deposit etc.). Once established on the website portal and server, said registration information inputted is then saved into computer memory via said server. The screenwriter enters a new website portal and follows contest instructions and uploads their screenplay submission through an upload function in the web portal. The hosts then retrieve screenplays from another website portal upload page (such as word files, PDF files, text files and the like) and review said documents and perform edits and critiques as they deem appropriate. Once the hosts select a winner, they notify the winning screenwriter(s) via email, telephone call etc. and issue a monetary compensation by means of paypal, stripe, venmo, direct deposit etc. Should there be additional contests, the website portal host repeats posting another contest listing and the inventive method repeats. If no other contests are required, the host then promotes said winning screenplay among producers and investors for potential film productions and once sold a portion of the profits (according to said website portal hosts) is paid to the winning screenwriter along with screen credits on any films produced.

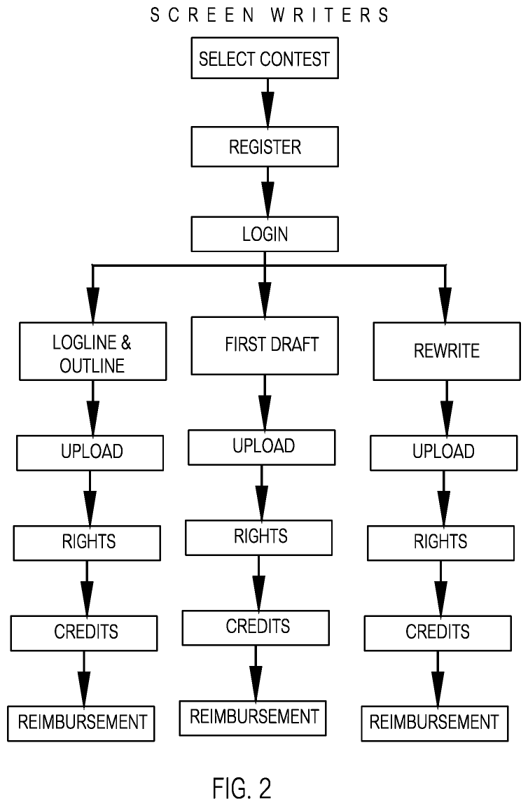

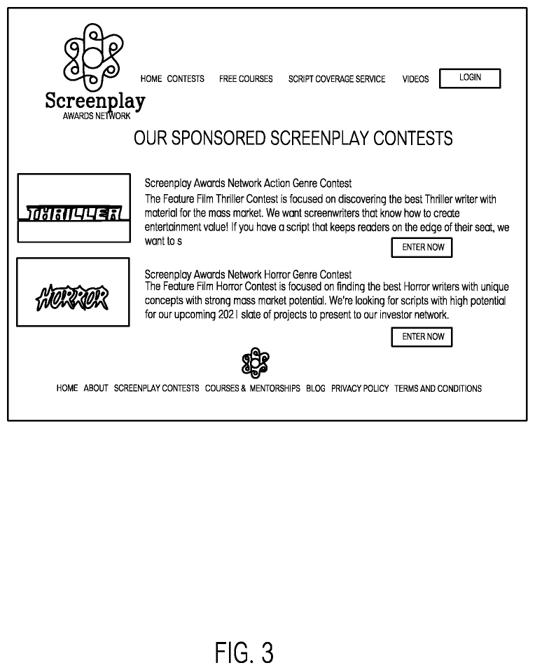

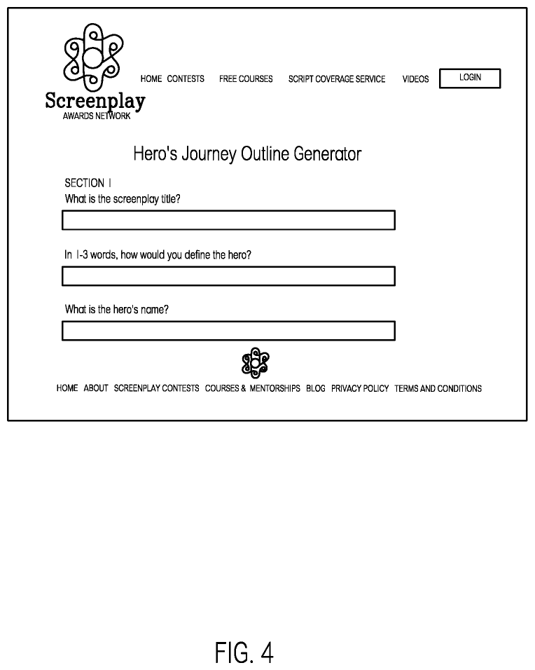

FIG. 2 showing the inventive method for screenwriters wherein said screenwriters select the contest in which they'd like to register, then registering their aforementioned demographics on a website portal page and establishing a user name and password and logging in to the system. Once logged in, the screenwriter follows contest instructions and uploads screenplay content files which are then saved into computer memory via said server. After uploading said screenplay, screenwriters providing a digital signature after reading and agreeing to allow the website portal host to secure the rights to the screenplay (in accordance to an agreement document drawn up and presented by the website portal host) upon which said signed agreement is then saved into computer memory via said server. The winning screenwriter then receiving screen credits and a reimbursement according to the website portal host predetermined amount. FIG. 3 showing an embodiment of a contest web page on the website portal having inventive methods that include but are not limited to a screenplay writer visiting the website portal and selecting a contest to enter by pressing the enter now button using their mouse. Other website options include free courses, script coverage services and video gallery. FIG. 4 showing an embodiment of a contest web page on the website portal having inventive methods that include but are not limited to a script outline generator wherein users enter screenplay language into input boxes based on questions listed on said website portal web page.

Those of skill in the art will recognize that mobile applications are written in several languages include, by way of non-limiting examples, C, C++, C#, Objective-C, Java, Javascript, Pascal, Object Pascal, Python, Ruby, VB.NET, WML, and XHL/HL with or without CSS, or combinations thereof. The app in invention 1 is also compatible with a plurality of operating systems such as, but not limited to: Windows, Apple, and Android, and compatible with a multitude of hardware platforms such as, but not limited to: personal desktops, laptops, tablets, smartphones and the like. Suitable mobile application development environments are available from several sources. Commercially available development environments include, by way of non-limiting examples, AirplaySDK, alcheMo, Appcelerator, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android SDK, BlackBerry SDK, BREW SDK, Palm OS SDK, Symbian SDK, webOS SDK, and Windows Mobile SDK. Those of skill in the art will recognize that several commercial forums are available for distribution of mobile applications including, by way of non-limiting examples, Apple App Store, Google Play, Chrome Web Store, BlackBerry App World, App Store for Palm devices, App Catalog for webOS, Windows Marketplace for Mobile, Ovi Store for Nokia devices, Samsung Apps, and Nintendo DSi Shop.

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications. In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe Flash Player, Microsoft Silverlight, and Apple QuickTime.

In view of the disclosure provided herein, those of skill in the art will recognize that several plug-in frameworks are available that enable development of plug-ins in various programming languages, including, by way of non-limiting examples, C++, Delphi, Java™, PHP, Python, and VB .NET, or combinations thereof. Web browsers (also called Internet browsers) are software applications, designed for use with network-connected digital processing devices, for retrieving, presenting, and traversing information resources on the World Wide Web. Suitable web browsers include, by way of non-limiting examples, Microsoft Internet Explorer, Mozilla Firefox, Google Chrome, Apple Safari, Opera Software Opera, and KDE Konqueror. In some embodiments, the web browser is a mobile web browser. Mobile web browsers (also called micro-browsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google Android browser, RIM BlackBerry Browser, Apple Safari, Palm Blazer, Palm WebOS Browser, Mozilla Firefox for mobile, Microsoft Internet Explorer Mobile, Amazon Kindle Basic Web, Nokia Browser, Opera Software Opera Mobile, and Sony PSP™ browser.

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth.

What is claimed is:

1. A method of accepting, acquiring, developing, judging and promoting screenplays, including the following inventive steps:
a) providing a computer having a memory and including input means for inputting information, and a display, and loading said computer with software for operating said method;
b) providing a server connecting said computer to a global computer network;
c) providing a website accessible to said computer via said global computer network and server whereby said software facilitates displaying images from said website on said display, said website including:
i) a main page with links to subsequent pages, clicking on said links facilitating access to said subsequent pages;
ii) said subsequent pages including:
A) a first page in which screenwriters select a contest made available by the web hosts;
B) a second page in which screenwriters input information to create and register a profile;
C) a third page in which screenwriters make payment transactions, agree to contest term transactions and enters contest;
D) a fourth page in which screenwriters download screenplay materials to edit as part of a contest;
E) a fifth page in which screenwriter uploads screenplay content as required as outlined in instructions, rules, and guidelines of the contest;
F) a sixth page in which website hosts view and organize screenplay writers' profiles and submitted contents;
G) a seventh page in which website hosts organize and view screenplays analysis and scores;
H) an eighth page in which website hosts list the names of screenwriters who have won a contest are displayed;
I) a ninth page in which screenplay rights are procured by transactions on the website hosts from the screenwriter and the screenwriter is given script developer or screenwriter credit by the website hosts;
J) a tenth page in which website hosts compensate screenwriters after winning screenplay is sold to producers and/or investors for potential film productions.

2. The method of submitting, judging and promoting screenplays of claim 1 wherein screenwriters selecting a contest made available by the web hosts on said first page includes the step of selecting from a logline and outline contest, a first draft contest, a rewrite contest, and a finished script contest.

3. The method of accepting, acquiring, developing, judging and promoting screenplays of claim 1 wherein the screenwriters input information to create and register a profile on said second page includes the step of inputting said profiles into said computer memory via said server.

4. The method of accepting, acquiring, developing, judging and promoting screenplays of claim 1 wherein said screenwriters make payment transactions, agree to contest term transactions and enter contests on said third page includes the step of transactions being recorded and saved to said computer memory via said server.

5. The method of accepting, acquiring, developing, judging and promoting screenplays of claim 1 wherein said screenwriters have entered contest and said third page also includes the step of the screenwriter downloading instructions, rules, guidelines, and timelines.

6. The method of accepting, acquiring, developing, judging and promoting screenplays of claim 1 wherein said screenwriters uploading screenplays as part of a contest on said fourth page includes the step of the screenwriter's work being uploaded manually and saved to said computer memory via said server.

7. The method of accepting, acquiring, developing, judging and promoting screenplays of claim 1 wherein said website hosts view and organize screenplay writers' profiles and submitted contest contents on said sixth page includes the step of organizing screenplay content scores being saved to said computer memory via said server.

8. The method of accepting, acquiring, developing, judging and promoting screenplays of claim 1 wherein said website hosts view and organize screenplay writer's screenplays on said seventh page includes the step of notes regarding said screenplays being saved to said computer memory via said server.

9. The method of accepting, acquiring, developing, judging and promoting screenplays of claim 1 wherein said website hosts a list of the names of screenwriters who have won a contest on said eighth page includes the step of being saved to said computer memory via said server.

10. The method of accepting, acquiring, developing, judging and promoting screenplays of claim 1 wherein said screenplay right transactions are procured by the website hosts from the screenwriter and the screenwriter is given script developer credit on said ninth page includes the step of said transactions being saved to said computer memory via said server.

11. The method of accepting, acquiring, developing, judging and promoting screenplays of claim 1 wherein said website hosts conduct promotional operations with winning screenplays to producers and investors for potential film productions on said tenth page includes the step of promotion operations being saved to said computer memory via said server.
